(19) United States
(12) Patent Application Publication
(10) Pub. No.: US 2008/0292286 A1
(43) Pub. Date: Nov. 27, 2008

(54) Video Information Recording and Outputting Method, Recording Media and Recording and Playback System

(76) Inventors: Takaharu Noguchi, Tokyo (JP); Hitoaki Owashi, Tokyo (JP); Akira Shibata, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/629,094

(22) PCT Filed: Jun. 10, 2005
(86) PCT No.: PCT/JP2005/010698

§ 371 Date: Feb. 12, 2008

(30) Foreign Application Priority Data
Jun. 11, 2004 (JP) 2004-173382

(51) Int. Cl. H04N 5/00

(52) U.S. Cl. 386/126; 386/E05.064

(57) ABSTRACT

It is a task of this invention to create a novel system (ubiquitous movie) that brings benefits to both a copyright holder of video information such as movies and general consumers who want to enjoy viewing the video information.

As for high image quality video information that the copyright holder wants to keep in a copy prohibited condition or the like, a copyright control such as copy prohibited condition is performed as is done with DVDs. In addition to the high image quality video information, a medium is recorded with another piece of video information whose image quality is limited to less than half the resolution of the high image quality video information, at which level the copyright holder can afford to permit the video information to be copied. This low image quality video information is attached with copyright protection information allowing copy, move and download operations as it is recorded in the medium. From this video information-recorded medium, the video information with the limited resolution is read out and recorded in a small medium that is easy to handle outdoors. The small medium containing the video information with the limited resolution is played in a video player that has a small display showing the played back video information.

### INCORPORATION BY REFERENCE

This patent application claims priority from Japanese Patent Application No. 2004-173382, filed on Jun. 11, 2004, which is incorporated herein by reference.

### TECHNICAL FIELD

The present invention relates to a digital information recording method and others.

### BACKGROUND ART

DVD discs have been in use as media for movies in recent years and DVD players for playing the DVD discs have also spread all over the world. A system for protecting copyrights of DVD discs used as the movie media is defined in “DVD Specifications for Read-Only Disc Part 1 Physical Specifications Version 1.02: September 1999 (page 44) Attached Sheets for DVD Specifications” (document 1).

The specifications for protecting copyrights describe copyright protection information associated with conditions for copying content recorded in the DVD—copy prohibited, first-generation copy allowed (copy once) and copy allowed.

An example of a DVD copyright protection system or a content scramble system (CSS) employed in the DVDs and DVD players to prevent illegal copying of DVDs by users is described in National Technical Report Vol. 43, No. 3 Jun. 1997 (pp. 339-341) (document 2).

### DISCLOSURE OF INVENTION

### Problem to be Solved by the Invention

To realize ubiquitous movie that allows users to enjoy video information such as movies outdoors with small, lightweight devices, copying the video information into a small, lightweight medium is required. However, no considerations have been given to this copying demand. In other words, the interests of movie copyright holders conflict with those of consumers who want to enjoy video information such as movies any time anywhere. Therefore, it is necessary to create a new system (ubiquitous movie) that can bring benefits to both parties.

The technology described in the document 2 (National Technical Report) encrypts content, such as copyrighted movie, recorded in the disc (copy prohibited) to prevent users from making illicit copy of the content. However, such individual DVD discs have only one piece of copyright protection information that limits copying of video information on a single medium and this document does not describe recording and playback of a medium that multiple pieces of video information with different copy limitations has been recorded in it. Therefore, for a DVD disc that records two or more pieces of digital information with different resolutions, one and the same copyright protection is applied to them. So, this copyright protection method, though it protects the interest of the copyright holder, leaves the unsolved problem with the interest of the user who wants to easily copy the digital information to other devices for later playback.

An optical disc with two recording layers, upper and lower, on one side is described in JP-A-11-312336 (document 3). This optical disc has video data with different resolutions recorded in the upper and lower layers and the recorded video data is played back by different pickup for each layer. This document 3, however, does not provide any means for protecting copyright from illegal copying. Therefore, this document leaves the problem of protecting the interest of copyright holder unsolved.

Under these circumstances, it is an object of this invention to provide a recording method conducive to both the copyright protection and the interest of the user.

An object of this invention is to enable recording on one and the same medium high image quality video information that is copy-prohibited and low image quality video information with the resolution limited to a level that allows the video to be viewed on a small display and copying the low image quality video information to a small medium. This system allows the user, for example, to play a small medium even outdoors and enjoy video information, such as movie, on a small display.

### MEANS FOR SOLVING THE PROBLEM

To achieve the above objective, this invention provides a recording method that records two or more pieces of digital information with different formats and which adds copyright protection information associated with the formats of the digital information and records the digital information attached with the copyright protection information associated with the formats.

### ADVANTAGES OF THE INVENTION

According to this invention, copyright can be protected.

Other objects, features and advantages of this invention will become apparent from the description of embodiments of this invention taken in conjunction with the accompanying drawings.

### BEST MODE FOR CARRYING OUT THE INVENTION

The present invention relates to a video information recording method which, from a medium having recorded in it both copy-prohibited, high image quality video information and copy-allowed, low image quality video information with a limited resolution, can suitably copy the low image quality video information to a small medium so that the low image quality video information can be played on a video player with a small display.

One embodiment of this invention will be explained.

FIG. 1 shows an example construction of an embodiment of an optical disc medium in which video information has already been recorded. Denoted 1 is an optical disc medium, 2 a recording area for first video information and 3 a recording area for second video information.

Next, a video information-recorded optical disc medium of the embodiment shown in FIG. 1 will be explained. As the optical disc medium 1, an optical disc with the same diameter of 12 cm as DVD is used. Video information is image-compressed with MPEG2 as copy-prohibited, first video information (640 pixels in a horizontal direction and 480 pixels in a vertical direction). Audio information is compressed with MPEG1, and both of these information and other information are synthesized to produce first digital data, which is then recorded in a recording area 2 in an inner circumference of the disc. Second video information (with 320 horizontal pixels and 240 vertical pixels), whose horizontal and vertical resolutions are limited to one-half of those of the first video information, is image-compressed with H.264AVC. Audio information is compressed with MP3 and both of these information and other information are synthesized to create second digital data, which is then recorded in a recording area 3. In this case, since the data volume of the second digital data is about ⅛ of that of the first digital data, the second digital data can easily be added to the present prerecorded DVD disc. Although the embodiment divides the recording area into the inner circumference and outer circumference, the first and second digital data may be recorded in the same area by a time-division multiplex manner.

The first and second video information are attached with copyright protection information which is related to the resolution of the video respectively. Alternatively, the copyright protection information may be attached to the first and second digital data. In that case, the copyright protection information is related to the level of compression or the format of the digital data. Generally, the copyright protection limitation often becomes moderate as the resolution decreases or the compression ratio of the digital data increases. The copyright protection information may include movie viewing limitation indication (film rating). In that case, the first and second video information have different film ratings.

Although this embodiment sets the high image quality video information at a resolution of 640×480 and the low image quality video information at 320×240, when an optical disc for a blue-violet laser is used as a medium, the high image quality video information may be set at a resolution of 1920×1080 and the low image quality video information at or below 960×540. Preferably there is a difference in resolution of at least two times between the high image quality and the low image quality. As for audio attached to video, it is also desired that the audio data accompanying the high image quality is compressed at a low compression ratio and that the audio data accompanying the low image quality is compressed at a higher compression ratio.

Although in this embodiment the same movie information is recorded in both the high and low image qualities, it is possible in accordance with the wishes of the copyright holder to edit the low image quality movie in a manner different from that of the high image quality movie so that the running time of the low quality movie will be shorter than that of the high quality movie.

Although this embodiment uses MPEG2 for the high image quality video information and H.264AVC for the low image quality video information as the image compression scheme, both information may be compressed with MPEG2 or H.264AVC or the low image quality video information may use VC9 that has good connectivity with personal computers.

One example of combining two pieces of video information may involve eliminating scenes of violence and obscenity undesirable for children from the first video information or lowering the resolution of such scenes to create edited second video information so that anyone can copy the second video information to a variety of media and enjoy viewing it anywhere.

While this embodiment uses an optical disc 12 cm in diameter as the optical disc medium, it is possible to use an 8-cm diameter optical disc in which to record both the first and second video information.

FIG. 2 shows an example configuration of a video player for the video information-recorded optical disc medium 1 of this invention.

In FIG. 2, denoted 5 is an optical disc device; 6 is a reader including an optical head 7 and a digital signal processing circuit 8 for error correction and so on; 9 is a signal processor similar to one used in the commonly available DVD player; 10 is an analog video signal; 11 is an audio signal; 12 is a flash memory card; 13 is a HDD; 14 is error-corrected first digital data; 15 is error-corrected second digital data; 16 is copyright protection information attached to the first video information; and 17 is copyright protection information attached to the second video information.

In FIG. 2, the optical disc device 5 is in a playback mode and the flash memory card 12 and HDD 13 are in a recording mode. The optical disc device 5 has a video information-recorded optical disc medium 1, 12 cm in diameter, mounted therein. The reader 6 reads the first video information and the second video information from the recorded optical disc medium 1 using the common optical head 7. The first and second video information are error-corrected by the common digital signal processing circuit 8, from which they are outputted as first digital data 14 and the second digital data 15.

The first digital data 14 is inputted to the signal processor 9, where the first digital data is decrypted by a decryption circuit 18, image and audio expansion are processed by an image expansion circuit 19 and an audio expansion circuit 20 and these informations are then attached with copy-prohibiting copyright protection information by a copyright information adding circuit 21, before being outputted as an analog video signal 10 and an audio signal 11.

The error-corrected second digital data 15 outputted from the reader 6 is inputted to the flash memory card 12 or HDD 13 to record the video and audio as compressed signal.

The reader 6 of FIG. 2 reads the copyright protection information (e.g., copy prohibited) 16 attached to the first video information by a copyright information reading circuit 22, and the copyright protection information 16 controls the copyright information adding circuit 21 of the signal processor 9 and it adds a Macrovision signal and a CGMS (Copy Generation Management System)—A (e.g., copy prohibited) to the analog video signal 10.

The copyright information reading circuit 22 in the reader 6 reads the copyright protection information (e.g., copy once) 17 attached to the second video information and adds copyright protection information (e.g., copy prohibited but move allowed) to the information to be recorded in the flash memory card 12 and HDD 13.

If a Veil signal (one-bit electronic watermarking representing a copy prohibited state) is attached with the first and second video, this Veil signal is also included in the analog video signal 10, the first digital data 14 and the second digital data 15. Although the Veil (copy prohibited) of the second video information 3 and the CGMS-D (copy once) conflict with each other, the copyright information reading circuit 22 ignores the Veil signal and reads only the CGMS-D. So, if the CGMS-D represents a copy once state, the second digital data 15 is recorded to either the flash memory card 12 or HDD 13 according to the selection made by the user. Therefore, in the second video information copied to the flash memory card 12 and HDD 13, Veil and CGMS-D coincide with each other.

FIG. 3 shows a video recorder of this invention. In FIG. 3, denoted 23 is an optical disc medium, 8 cm in diameter, 24 is a signal selection circuit, 25 is a second digital data for recording, and 26 is an optical disc writing device.

In FIG. 3, the flash memory card 12 and HDD 13 are in a playback mode and the optical disc device 5 is in a recording mode. The recordable optical disc medium 23, 8 cm in diameter, is set in the optical disc device 5 and the second digital data reproduced from the flash memory card 12 or HDD 13 and selected and outputted by the signal selection circuit 24 is written into the small optical disc medium 23 through the writing device.

The second digital data 25 is also supplied to the signal processor 9 where the image expansion circuit 19 and the audio expansion circuit 20 check the image compression scheme and the audio compression scheme of the second digital data 25 and switch the image decoder of the image expansion circuit 19 to H.264AVC and the audio decoder of the audio expansion circuit 20 to MP3, to output an analog video signal 10 and an audio signal 11. The writing device 26 reads copyright protection information from the second digital data 25, writes copyright protection information (e.g., move prohibited and copy prohibited) different from that of the second digital data 25 into the small optical disc 23, outputs copyright protection information (e.g., copy prohibited) different from the above data 25 also to the signal processor 9, and adds a Macrovision signal and CGMS-A (copy prohibited) to the analog video signal 10.

FIG. 4 shows an example of a video player with a small display used outdoors to play the small optical disc medium 23 made in FIG. 3.

In FIG. 4, denoted 27 is a video player with a small display; 28 is a playback device for 8-cm in diameter optical disc medium 23; 29 is a signal processing circuit to reproduce the first and second video information; 30 is a small display; 31 is a copyright protection information reading circuit to read copyright protection information and Veil and electronic watermarking information; 32 is video information including the Veil and electronic watermarking information; 33 is a video signal control signal; 34 is a video signal output terminal; and 35 is an audio signal output terminal.

In FIG. 4, information recorded in the small optical disc medium 23 is read out by the optical disc playback device 28 and supplied to the signal processing circuit 29 where it is decrypted, image-expanded, audio-expanded and also subjected to a video signal output control. The processed video signal is then outputted to the small display 30 and to the video signal output terminal 34 and the processed audio signal is outputted to the audio signal output terminal 35.

In addition to the optical disc medium such as shown in FIG. 3 that records low image quality video information or the second video information, other optical discs may be used. They include a prerecorded 8-cm optical disc medium that has recorded in the same medium the first video information or high image quality video information and the second video information and a commercially available prerecorded 8-cm optical disc medium that contains high image quality information. The video player 27 with a small display can play these 8-cm optical disc media.

Among information recorded in these 8-cm optical disc media, there are a movie as high image quality video information recorded in the DVD standard and a movie with a limited resolution. Which of these image qualities of the movies are to be played with may be determined by the user or preset as a default. The signal processing circuit 29 is required to check which image quality of the movie represents the signal from the optical disc playback device 28. If the two image qualities use different encryption schemes, the first step is to check the encryption scheme. According to the result of the check, decryption is executed and then the next check is made as to the video and audio compression scheme and the video resolution information. According to these check results, the video expansion and audio expansion are executed.

If the video signal includes Veil information and electronic watermarking information, the copyright protection information reading circuit 31 reads the copyright protection information and Veil and electronic watermarking information contained in the video information 32. If the copyright protection information does not coincide with the Veil information or electronic watermarking information, the copyright protection information reading circuit 31 controls the signal processing circuit 29 using the video signal control signal 33 and stops supplying the video signal to the small display 30.

If it is determined that the information read out is high image quality video information, the signal processing circuit 29 always supplies the high image quality video signal to the video signal output terminal 34. If it is decided that the information read from the small optical disc medium 23 is low image quality video information, the signal processing circuit 29 stops supplying the video signal to the video signal output terminal 34.

The video player 27 with a small display of this invention shown in FIG. 4 is a portable video player with a small display which allows the user not only to enjoy viewing videos outdoors but also to connect the player to a large indoor display when he or she wishes to view high image quality first video information.

In the embodiment of FIG. 4, if the information read out is determined by the signal processing circuit 29 to be high image quality video information, the video signal and audio signal are output from the video signal output terminal 34 and the audio signal output terminal 35, respectively. It is also possible to provide a digital signal output terminal (not shown in this embodiment) that outputs a bit stream signal including the error-corrected, as-compressed video and audio signals from the signal processing circuit 29. As the digital signal output terminal, 1394 is available which has a copyright protection function to add copyright protection information on the video signal before transmitting the digital signal. Also as the digital signal output terminal, HDMI (High-Definition Multimedia Interface) may be provided which outputs digital data including base-band video and audio signals that are image-expanded and audio-expanded by the signal processing circuit 29, rather than the as-compressed bit stream signal. The above digital signal output terminal may replace the video signal output terminal 34 and the audio signal output terminal 35, or may be added.

While the optical disc playback device 28 for the optical disc medium 23 is shown in FIG. 3 of this embodiment, a playback device to play back video information recorded in the flash memory card 12 or HDD 13 may be used.

This invention allows the user to additionally record video information such as movie, that can be enjoyed with a small display, into an existing medium such as DVD by adopting a resolution limitation or an image compression scheme with high compression ratio, with which the copyright holder can afford to permit the secondary use of the video information. With this invention, the copyright holder can realize a business of selling prerecorded, value-added media containing movies or other contents. General users can easily enjoy viewing the video information such as movies outdoors using a small medium and a small display.

With this invention, digital information with a predetermined resolution (or predetermined compression ratio) and digital information with a lower resolution (or higher compression ratio) are attached with different copyright protection information as related to the resolution and compression ratio. For example, copyright protection information such as copy prohibited may be added to the digital information with a predetermined resolution or compression ratio. And to the digital information with a lower resolution or higher compression ratio is added copyright protection information, such as copy once or move allowed, whose restriction level is moderate when compared to that of the digital information with the predetermined resolution or compression ratio. This method can therefore protect the copyright and the interest of the copyright holder and at the same time contribute to the interest of the user.

### INDUSTRIAL APPLICABILITY

The present invention is effectively applied to a system that allows a small optical disc medium, to which low image quality video information with a limited resolution such as movies has been copied, to be played even outdoors in a playback device with a small display.

Although the above descriptions have been made in conjunction with the example embodiments, it is apparent to those skilled in the art that this invention is not limited to these and that various changes and modifications may be made within the spirit of this invention and the scope of the appended claims.

### BRIEF DESCRIPTION OF THE DRAWINGS

FIG. 1 An example embodiment of a video information-recorded optical disc medium according to this invention.

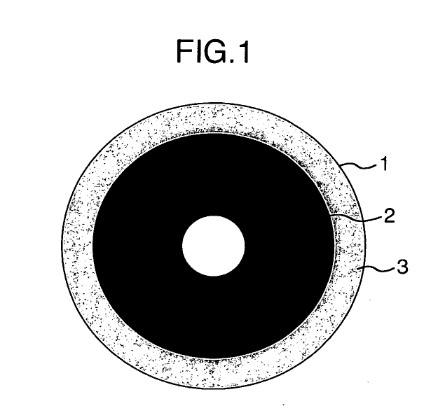

FIG. 2 A block diagram showing an embodiment of a video player according to this invention that plays a video information-recorded optical disc medium.

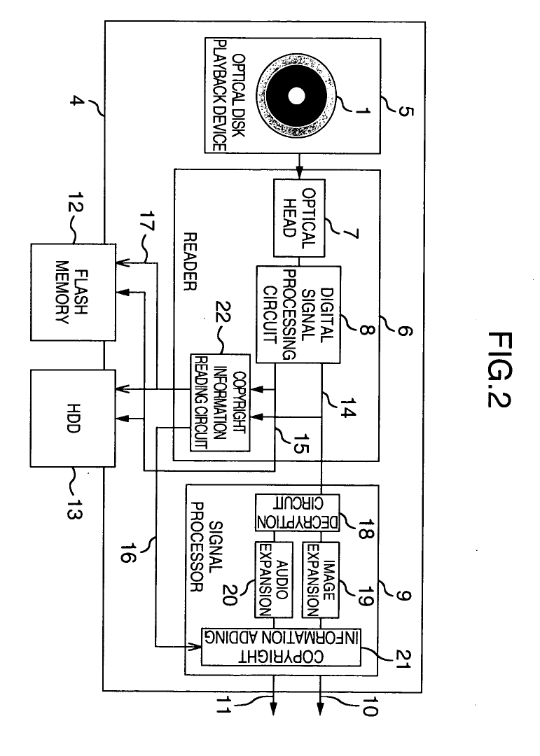

FIG. 3 A block diagram showing an embodiment of a video recorder according to this invention.

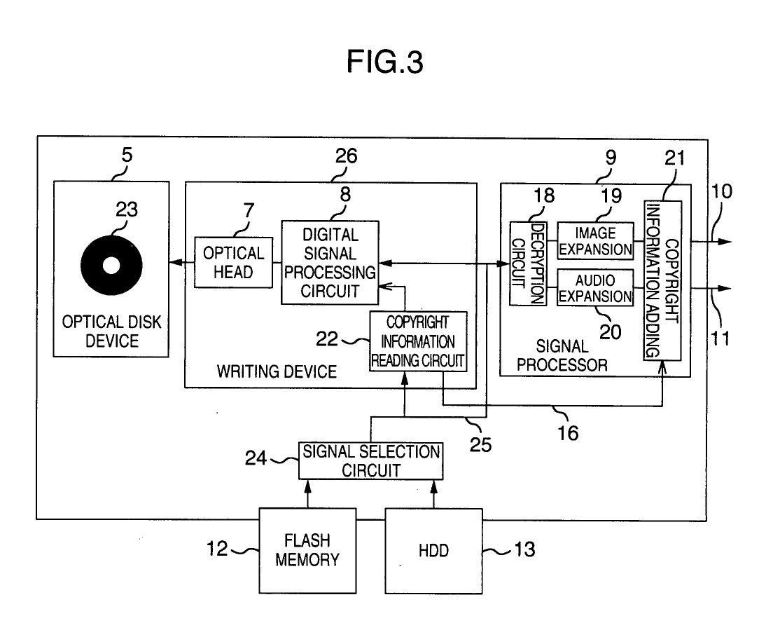

FIG. 4 A block diagram showing an embodiment of a video player for small disc with a small display according to this invention.

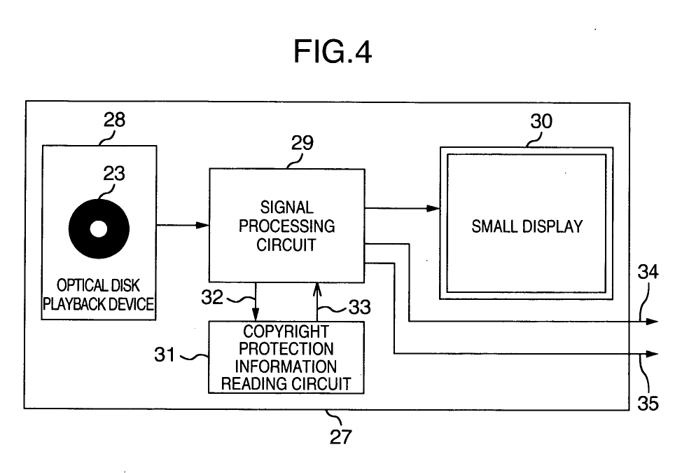

1-20. (canceled)

21. A recording method for recording at least two pieces of video information with different resolutions which are generated based on same original video information, comprising the steps of:
adding copyright protection information related to the resolutions of the video information to the at least two pieces of video information with different resolutions; and
recording the video information attached with the copyright protection information related to the resolutions.

22. An output method for playing back and outputting video information from a medium in which two or more pieces of video information with different resolutions which are generated based on same original video information are recorded,
wherein the video information stored in the medium is attached with copyright protection information related to the resolutions of the video information, and
the played back video information is output to different destinations according to the resolutions of the video information.

23. An output method according to claim 22, wherein when the resolution of the played back video information is a predetermined resolution, the played back video information is outputted to the outside;
wherein when the resolution of the played back video information is lower than the predetermined resolution, the played back video information is outputted to a built-in display.

24. An output method according to claim 22,
wherein the at least two pieces of video information are stored after they are compressed,
wherein when the compression ratio of the played back digital information is a predetermined compression ratio, the played back video information is outputted to the outside,
wherein when the compression ratio of the played back digital information is higher than the predetermined compression ratio, the played back digital information is outputted to a built-in display.

25. A recording method for recording first video information with a predetermined resolution and second video information with a lower resolution, the first and second video information being generated based on same original video information, the recording method comprising the steps of:
adding first copyright protection information to the first video information;
adding second copyright protection information with a lower limitation than the first copyright protection information to the second video information; and
recording the first video information attached with the first copyright protection information and the second video information attached with the second copyright protection information.

26. A recording method according to claim 25,
wherein video information with a high resolution is attached with copyright protection information having a higher limitation than that of video information with a lower resolution; and
wherein video information with a lower resolution is attached with copyright protection information having a lower limitation than that of video information with a higher resolution.

27. A recording method according to claim 25,
wherein the first video information attached with the first copyright protection information and the second video information attached with the second copyright protection information are recorded in different areas on the recording medium.

28. A recording method according to claim 25,
wherein the first video information and the second video information are compressed using different compression schemes.

29. A recording method for recording at least two pieces of digital information with different compression ratios which are generated based on same original video information, comprising the steps of:
adding copyright protection information related to the compression ratios of the digital information; and
recording the digital information attached with the copyright protection information related to the compression ratios.

30. An output method for playing back and outputting digital information from a medium in which at least two pieces of digital information with different compression ratios which are generated based on same original video information are recorded,
wherein the digital information stored in the medium is attached with copyright protection information related to the compression ratios of the digital information, and
the played back digital information is output to different destinations according to the compression ratios of the digital information.

31. A recording method for recording first digital information with a predetermined compression ratio and second digital information with a higher compression ratio, the first and second digital information being generated based on same original video information, the recording method comprising the steps of:
adding first copyright protection information to the first digital information;
adding second copyright protection information with a lower limitation than the first copyright protection information to the second digital information; and
recording the first digital information attached with the first copyright protection information and the second digital information attached with the second copyright protection information.

32. A recording method according to claim 31,
wherein digital information with a low compression ratio is attached with copyright protection information having a higher limitation than that of video information with a higher compression rate;
wherein digital information with a higher compression ratio is attached with copyright protection information having a lower limitation than that of digital information with a lower compression ratio.

33. A recording method according to claim 7, wherein the first digital information attached with the first copyright protection information and the second digital information attached with the second copyright protection information are recorded in different areas on the recording medium.

34. A recording medium having recorded therein at least two pieces of video information with different resolutions which are generated based on same original video information, wherein the two or more pieces of video information with different resolutions are each attached with copyright protection information related to the resolutions of the video information.

35. A recording medium having recorded therein
first video information attached with first copyright protection information; and
second video information attached with second copyright protection information having a lower limitation than the first copyright protection information, the first and second video information being generated based on same original video information,
wherein the first video information has a higher resolution than the second video information.

36. A recording medium according to claim 35,
wherein the second video information is edited and recorded such that running time of the second video information is shorter than running time of the first video information.

37. A recording medium having recorded therein
first digital information attached with first copyright protection information and
second digital information attached with second copyright protection information having a lower limitation than the first copyright protection information, the first and second digital information being generated based on same original video information,
wherein the second digital information is compressed at a higher compression ratio than the first digital information.

38. A recording medium according to claim 37, wherein the first digital information and the second digital information are compressed using different compression schemes and the first digital information and the second digital information are recorded in different areas on the recording medium.

39. A recording medium according to claim 38,
wherein the second digital information is edited and recorded such that running time of the second digital information is shorter than running time of the first digital information.

40. A recording medium according to claim 37,
wherein the second digital information is edited and recorded such that running time of the second digital information is shorter than running time of the first digital information.

41. A video information recording/playback system for recording in at least the same medium first video information with a first resolution and first copyright protection information and second video information with a second resolution and second copyright protection information;
wherein the first resolution of the first video information is set at more than two times the second resolution of the second video information and the first copyright protection information is set at a more stringent copyright condition than the second copyright protection information.

42. A video information recording/playback system according to claim 41,
wherein the first video information is compressed with a first video compression scheme and the second video information is compressed with a second video compression scheme; and
wherein the second video compression scheme is chosen so that a video data compression ratio of the second video compression scheme is higher than that of the first video compression scheme.

43. A video information recording/playback system according to claim 42,
wherein the first video compression scheme is different from the second video compression scheme.

44. A video information recording/playback system according to claim 41,
wherein second audio information accompanying the second video information is compressed with a second audio compression scheme before being recorded;
wherein first audio information accompanying the first video information is compressed with a first audio compression scheme before being recorded; and
wherein the second audio compression scheme is chosen so that an audio data compression ratio of the second audio compression scheme is higher than that of the first audio compression scheme.
